(19) United States
(12) Patent Application Publication
(10) Pub. No.: US 2004/0150339 A1
(43) Pub. Date: Aug. 5, 2004

(54) Plasma display screen with corrugated separating ribs

(76) Inventors: Markus Heinrich Klein, Heerlen (NL); Rob Snijkers, Heerlen (NL)

Correspondence Address: Philips Corporation, Intellectual Property Department, P O Box 3001, Briarcliff Manor, NY, 10510, US

(21) Appl. No.: 10/479,093

(22) PCT Filed: Jun. 3, 2002
(86) PCT No.: PCT/IB02/02010

(30) Foreign Application Priority Data
Jun. 1, 2001 (DE) 101 26 930.7

(51) Int. Cl. H01J 17/49

(52) U.S. Cl. 313/582

(57) ABSTRACT

A plasma display screen comprising a carrier plate, a transparent front plate, a ribbed structure of a number of essentially parallel, zigzaggedly configurated separating ribs composed of first essentially parallel segments arranged at a first distance from each other, and of second essentially parallel segments arranged at a second distance from each other that is larger than the first distance, and of third segments interconnecting the first and the second segments, and comprising a phosphor coating between the separating ribs, a number of elongated address electrodes arranged on the carrier plate substantially parallel to the orientation of the separating ribs, and a plurality of elongated discharge electrodes with transparent strip electrodes and bus electrodes, which are arranged on the front plate essentially orthogonally to the orientation of the separating ribs, said bus electrodes alternately comprising segments which are arranged parallel to the third segments of the separating ribs and segments arranged transversely to the first segments of the separating ribs.

The invention relates to a plasma display screen of the surface-discharge type comprising a carrier plate, a transparent front plate, a ribbed structure of a number of essentially parallel, zigzaggedly configurated separating ribs composed of first essentially parallel segments arranged at a first distance from each other, and of second essentially parallel segments arranged at a second distance from each other that is larger than the first distance, and of third segments interconnecting the first and the second segments, which segments divide the space between carrier plate and front plate into plasma cells that are filled with a gas, and comprising a plurality of elongated discharge electrodes with transparent strip electrodes and bus electrodes, which are arranged on the front plate essentially orthogonally to the orientation of the separating ribs, and comprising a plurality of elongated address electrodes arranged on the carrier plate substantially parallel to the orientation of the separating ribs.

In known plasma display screens of the surface-discharge type, the plasma is generated by a gas discharge in a three-electrode system. Said three-electrode system comprises one address electrode and two discharge electrodes per picture element, between which an alternating voltage is applied during operation.

Plasma display screens of this type comprise a transparent front plate and a carrier plate, which plates are held at a distance from each other and are hermetically sealed at the periphery. The space between both plates forms the discharge space containing a gas filling for the gas discharge.

The inner side of the front plate carries a number of pairs of elongated discharge electrodes, which pairs are arranged parallel to each other.

The inner side of the carrier plate carries a number of elongated address electrodes, which are also arranged parallel to each other and orthogonally to the discharge electrodes.

The front plate and the carrier plate are mounted such that the longitudinal direction of the discharge electrodes is arranged orthogonally to the longitudinal direction of the address electrodes. Each point of intersection of a pair of discharge electrodes and an address electrode defines a plasma cell, i.e. a discharge region in the discharge space. Individually controllable plasma cells are formed by a ribbed structure of linear separating ribs, which are arranged on the carrier plate between the address electrodes and divide the gas discharge space into parallel discharge channels.

For a color display screen, the picture elements of the plasma display screen are formed in the three primary colors red, blue and green by three parallel phosphor strips on the carrier plate between the separating ribs and/or on the walls of the separating ribs.

In these plasma display screens, each pair of discharge electrodes must be kept at a distance from the next pair of discharge electrodes so as to preclude crosstalk of the gas discharge inside the discharge channels. A further drawback resides in that the width of a pixel, which is composed of three sub-pixels, is at least equal to that of three discharge channels. Due to both drawbacks, it is impossible to accommodate more pixels on a given display screen surface.

U.S. Pat. No. 5,825,128 already discloses a plasma display screen of the surface-discharge type, wherein the discharge electrodes are arranged in parallel and equidistantly, and the discharge is ignited from one electrode alternately to one of the two neighboring discharge electrodes and the other. Furthermore, the ribbed structure consists of periodically corrugated separating ribs which divide the gas discharge space into separate, parallel chains of plasma cells.

A drawback of this arrangement of corrugated separating ribs and parallel discharge electrodes resides in that the metallic buses of the discharge electrodes extend partially over the plasma cells, as a result of which they reflect the light radiation emitted by the pixels and hence reduce the brightness of the plasma display screen.

It is an object of the invention to provide a plasma display screen with corrugated separating ribs, which plasma display screen is characterized by increased brightness and improved contrast.

In accordance with the invention, this object is achieved by a plasma display screen comprising a carrier plate, a transparent front plate, a ribbed structure of a number of essentially parallel, zigzaggedly configurated separating ribs composed of first essentially parallel segments arranged at a first distance from each other, and of second essentially parallel segments arranged at a second distance from each other that is larger than the first distance, and of third segments interconnecting the first and the second segments, and comprising a phosphor coating between the separating ribs, a number of elongated address electrodes arranged on the carrier plate substantially parallel to the orientation of the separating ribs, and a plurality of elongated discharge electrodes with transparent strip electrodes and bus electrodes, which are arranged on the front plate essentially orthogonally to the orientation of the separating ribs, said bus electrodes alternately comprising segments which are arranged parallel to the third segments of the separating ribs and segments arranged transversely to the first segments of the separating ribs.

By virtue of such discharge electrodes comprising segmented, zigzaggedly configured bus electrodes, which are arranged substantially over the separating ribs, the reflection of light from the phosphor layer at the bus electrodes is reduced and the brightness and contrast of the plasma display screen increased.

In accordance with an embodiment of the invention, the bus electrodes comprise a light-absorbing material to further increase the contrast of the plasma display screen.

In accordance with a preferred embodiment of the invention, the strip electrodes of the discharge electrodes comprise segments arranged parallel to the third segments of the separating ribs, segments arranged transversely to the first segments of the separating ribs and branches arranged over the plasma cells. As a result, the plasma cloud generated by the gas discharge is kept away from the walls of the plasma cell and wall losses are minimized. It is particularly preferred that the branches are hammer-shaped.

These and other aspects of the invention are apparent from and will be elucidated with reference to the embodiment(s) described hereinafter.

In the drawings:

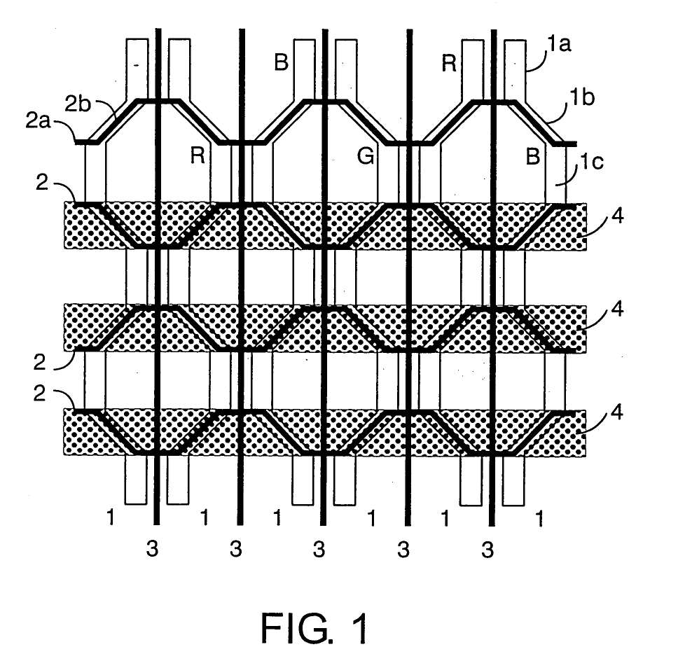

FIG. 1 is a plan view of a plasma display screen with corrugated separating ribs and discharge electrodes with corrugated bus electrodes.

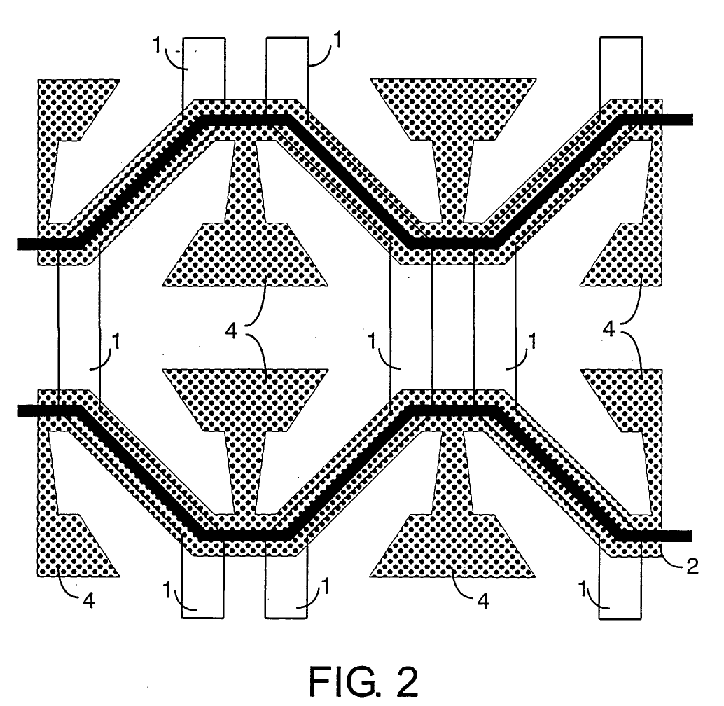

FIG. 2 is a plan view of a plasma display screen with corrugated separating ribs and discharge electrodes with corrugated bus electrodes and corrugated strip electrodes with hammer-shaped branches.

In accordance with an embodiment of the invention, the plasma display screen comprises a carrier plate, a transparent front plate, a ribbed structure 1 of a plurality of essentially parallel separating ribs that divide the space between the carrier plate and the front plate into plasma cells filled with a gas.

The separating ribs are arranged in accordance with a zigzag configuration of first essentially parallel segments 1a, which are arranged at a first distance from each other, second essentially parallel segments 1c, which are arranged at a second distance from each other that is larger than the first distance, and third segments 1b which interconnect the first and the second segments. Each separating rib forms a segmented line, such that the individual segments are successively rotated twice through an angle +α and subsequently twice through an angle −α relative to each other. The angle α ranges from 90° <α<180°. Preferably, the angle α is approximately 120°±10°. The neighboring separating ribs are each arranged so as to be the mirror image of said separating ribs. Thus, each time two separating ribs form a row of plasma cells that are concatenated in a discontinuous chain-type manner along a common discharge channel. The plasma cells along a common discharge channel are each coated with a phosphor emitting one of the three primary colors red, green or blue.

The carrier plate additionally carries a number of elongated address electrodes 3, which are arranged on the carrier plate substantially parallel to the direction of the separating ribs below the discharge channel. The front plate carries a number of elongated discharge electrodes 2 which are arranged on the front plate essentially orthogonally to the orientation of the separating ribs. Each individual discharge electrode comprises a transparent strip electrode 2b and a bus electrode 2a laminated on the transparent strip electrode. Preferably, the bus electrodes are made of a metal and are not transparent.

The bus electrodes of the discharge electrodes comprise alternately segments arranged parallel to the third segments of the separating ribs and segments arranged transversely to the first segments of the separating ribs. The segments that extend transversely to the first segments of the separating ribs have a length that substantially corresponds to the width of the discharge channel at the location where said discharge channel is narrowest. The segments of the bus electrodes form a segmented line, such that the individual segments are successively rotated twice through an angle +α and subsequently twice through an angle −α relative to each other.

If an orthogonal co-ordinate system x, y, z is assigned to the plasma display screen, so that x is the longitudinal direction of the discharge electrodes, y is the longitudinal direction of the address electrodes, xy is the plane of the two substrates and z is the direction at right angles to the substrates, then the bus electrodes, viewed in the z-direction, are essentially situated over the separating ribs. The bus electrodes form a segmented line that follows the course of the separating ribs and crosses the discharge channel at the location where said discharge channel is narrowest.

The material used for the bus electrodes is preferably aluminum, copper, gold, titanium, nickel, tungsten, molybdenum or calcium, or alloys of these metals, which have a high conductivity, so that they can be manufactured with a small cross-section. The bus electrodes may also be provided with a coating of a light-absorbing material in order to avoid reflections at the faces of the bus electrodes. Alternatively, the surface of the bus electrodes can be roughened.

The transparent strip electrodes can form, in the unsegmented state, a substantially straight block strip that extends transversely across the third segments of the separating ribs.

Advantageously, additional measures are taken to counteract crosstalk of the gas discharge from one sub-pixel to the adjacent sub-pixels in the x direction, and simultaneously keep the gas discharge away from the walls of the plasma cell.

To achieve this, the strip electrodes, as shown in FIG. 2, alternately exhibit different regions within which the discharge is started or suppressed. In this embodiment of the invention, the strip electrodes comprise segments arranged parallel to the third segments of the separating ribs, segments arranged transversely to the first segments of the separating ribs and branches (4) which are arranged over the plasma cells.

As a result, the plasma cloud generated by the gas discharge is kept away from the walls of the plasma cells and wall losses are minimized. In addition, radial discharge structures are suppressed, the discharge burns rather directly towards the adjacent area of the counterelectrode.

By way of example, FIG. 2 shows an embodiment of the discharge electrodes wherein the strip electrodes comprise hammer-shaped branches 4. Said branches extend transversely to the longitudinal direction of the strip electrodes, in such a manner that the branches of adjacent strip electrodes lie opposite each other at the same level and bound the discharge channel.

In accordance with a different embodiment of the invention, the segments may be trapezoidal.

In a simple embodiment, the branches may be shaped like rectangular comb teeth.

Said branches are arranged at regular intervals corresponding to the width of a sub-pixel. During mounting the plasma display screen, said branches are arranged such that they extend over the plasma cells.

For the material of the transparent strip electrodes use is customarily made of a transparent conductive material, such as indium-doped tin oxide (ITO) or non-stoichiometric tin oxide SnOₓ.

The front plate customarily further comprises a transparent, first dielectric layer that covers the pairs of electrodes. Said transparent dielectric layer has a substantially constant thickness d over the strip electrodes. As a result, the relief of the dielectric layer substantially corresponds to the relief of the inner surface of the front plate.

At the high voltage used, the dielectric layer can suitably be made of puncture-proof, electrically insulating materials (dielectrics), such as borosilicate glass, glass frit, quartz glass, Al₂O₃, MgF₂, LiF, BaTiO₃.

However, the choice of the dielectric material is not limited to said materials. Other dielectric materials having paraelectric, ferroelectric and anti-ferroelectric properties can also be used.

The plasma display screen may have a simple matrix address, where the discharge is ignited between a discharge electrode and an address electrode. In accordance with a different embodiment of the invention, the plasma display screen is of the surface-discharge type with three electrodes per plasma cell, where the gas discharge is ignited between a pair of discharge electrodes and controlled by quenching pulses from the address electrode.

In a particularly preferred embodiment of the plasma display screen, where the discharge electrodes are arranged equidistantly instead of in pairs, and either one of said discharge electrodes is capable of igniting a gas discharge for one plasma cell with both adjacent discharge electrodes (AliS).

To manufacture a plasma display screen in accordance with the invention, use is made of a glass carrier plate with a surface relief of elongated, corrugated separating ribs of segments that are offset with respect to each other.

The carrier plate is made in accordance with known methods. First, the address electrodes are manufactured by vapor depositing and structuring a material. Next, the ribs of the carrier plate can be built up from a glass paste by means of, for example, repeated screen printing. The areas between the ribs of the carrier plate are coated alternately with a phosphor for red, green and blue.

Such a carrier plate can also be manufactured as a molded part by compression molding, spin coating or extruding. A carrier plate with corrugated separating ribs having offset segments can alternatively be manufactured by removing parts from said carrier plate by a sandblasting process.

The front glass plate is customarily made of a borosilicate glass, which can be etched, de-reflected, doped or subjected to other pre-treating operations.

The cleaned glass surface is provided with a coating of the material for the transparent strip electrodes. The transparent strip electrodes can be deposited on the glass front plate by means of conventional coating methods, such as CVD, vapor deposition, sputtering, a sol-gel process and the like. In accordance with a preferred method of manufacturing, the glass front plate is coated with a layer of tin oxide or indium-doped tin oxide in a sol-gel process and subsequently this layer is structured so as to form strip electrodes by means of photolithographic masking and etching.

In the next process step, a material for the bus electrodes is provided on the strip electrodes, for example by means of vapor deposition, a CVD process, currentless or electrolytic wet deposition, or sputtering, after which it is structured by means of a photolithographic process and etching.

Subsequently, the electrodes and the free areas of the front plate are coated with a layer of a dielectric material, such as glass paste, and, finally, a second dielectric layer containing, for example, MgO may be provided.

The front plate with the discharge electrodes and the carrier plate with the address electrodes are interconnected in a gastight manner such that the address electrodes and the discharge electrodes extend perpendicularly to each other, and the gas space is filled with a gas mixture containing, for example, an inert gas such as xenon.

1. A plasma display screen comprising a carrier plate, a transparent front plate, a ribbed structure of a number of essentially parallel, zigzaggedly configurated separating ribs composed of first essentially parallel segments arranged at a first distance from each other, and of second essentially parallel segments arranged at a second distance from each other that is larger than the first distance, and of third segments interconnecting the first and the second segments, and comprising a phosphor coating between the separating ribs, a number of elongated address electrodes arranged on the carrier plate substantially parallel to the orientation of the separating ribs, and a plurality of elongated discharge electrodes with transparent strip electrodes and bus electrodes, which are arranged on the front plate essentially orthogonally to the orientation of the separating ribs, said bus electrodes alternately comprising segments which are arranged parallel to the third segments of the separating ribs and segments arranged transversely to the first segments of the separating ribs.

2. A plasma display screen as claimed in claim 1, characterized in that the bus electrodes contain a light-absorbing material.

3. A plasma display screen as claimed in claim 1, characterized in that the strip electrodes comprise segments arranged parallel to the third segments of the separating ribs, segments arranged transversely to the first segments of the separating ribs and branches arranged over the plasma cells.

4. A plasma display screen as claimed in claim 3, characterized in that the branches are hammer-shaped.
